(19) United States
(12) Patent Application Publication
(10) Pub. No.: US 2006/0209622 A1
(43) Pub. Date: Sep. 21, 2006

(54) Holding apparatus for buckets

(76) Inventor: George Kennedy, Roosevelt, UT (US)

Correspondence Address: THORPE NORTH & WESTERN, LLP., 8180 SOUTH 700 EAST, SUITE 200, SANDY, UT, 84070, US

(21) Appl. No.: 11/377,878

(22) Filed: Mar. 15, 2006

Related U.S. Application Data
(60) Provisional application No. 60/662,487, filed on Mar. 16, 2005.

(51) Int. Cl. B01F 15/00

(52) U.S. Cl. 366/129; 366/349

(57) ABSTRACT

An apparatus to hold a bucket from spinning while the contents of the bucket are being mixed or stirred includes a bucket holder which fits and locks around the bucket and a leg stop extending from the bucket holder that fits against the user's leg to prevent spinning of the bucket. The bucket holder may include a strap which is tightened around the outside of the bucket to snugly hold the bucket in a closed loop of the strap. In one embodiment the strap is held in closed looped position by a buckle. A leg stop which rests against the leg of a user during use of the apparatus is secured to the bucket holder and extends outwardly therefrom to contact the leg of the user.

### RELATED APPLICATION

This application claims the benefit of provisional Application Ser. No. 60/662,487 filed Mar. 16, 2005, and titled “Holding Apparatus for Buckets.”

### BACKGROUND OF THE INVENTION

1. Field

The invention is in the field of devices for holding buckets or similar containers, particularly five gallon buckets, which are commonly used to mix materials, and which have a tendency to spin during mixing of the materials.

2. State of the Art

It is currently common practice for people to mix various products in containers, such as five gallon buckets, to prepare the products for use. Dry products commonly mixed in such containers include concrete or cement mix, stucco mix, dry wall mud mix, etc., which are mixed with water to prepare them for use at a job site. Premixed products, such as dry wall mud, which may separate during storage, are also commonly mixed at job sites. Such products may be mixed by hand with a mixing paddle, or, in many cases are mixed with a mixing attachment attached to a power drill. During such mixing, since the products are relatively stiff and stick to the sides of the bucket during mixing, the bucket tends to move and spin. This is particularly true when using a mixing attachment with a power drill or other power device for mixing the product since the mixing attachment is spun by the drill, which tends to spin the bucket in the same direction of spin as the mixing device. This tendency for the bucket to spin is also present for liquids, such as paint, which are often mixed with power drill mixing attachments, but is not as strong as the viscosity of the paint is less than for the above mentioned materials. The higher the viscosity of the materials to be mixed, the stronger the tendency of the bucket to spin.

Current practice is to try to hold the bucket with the person's feet and legs during mixing. This is difficult because the bucket is hard to hold against spinning with the feet and legs and because the person has to assume an unnatural position to try to hold the bucket from spinning while at the same time holding and moving the mixing implement. If the bucket spins during mixing, mixing does not take place. Further, the spinning bucket is dangerous and can injure the person trying to hold the bucket. In addition, the spinning bucket is out of control and can tip and spill the contents. A better way to hold a bucket during mixing a product in the bucket is needed.

### SUMMARY OF THE INVENTION

The invention provides an apparatus or device to hold a bucket from spinning while the contents of the bucket are being mixed or stirred. The device includes a bucket holder which fits and locks around the bucket and a leg stop extending from the bucket holder that fits against the user's leg to prevent spinning of the bucket. In this way, the bucket is still located between a user's feet and legs during mixing, but the user can stand normally to mix the contents of the bucket. Rotation of the bucket is prevented by the leg stop acting against the user's leg, rather than by a user having to squeeze his or her legs against the bucket with enough force to prevent rotation.

In one embodiment of the invention, the bucket holder consists of a strap of substantially flexible but substantially nonstretchable material looped into a generally circular configuration, with ends of the strap attached through a buckle or locking mechanism. The buckle can be moved between an open position which provides an enlarged loop, and a closed position which provides a smaller loop of reduced diameter. The device is sized to provide a closed position loop diameter that will snugly hold the bucket to be held by the device. A rigid U-shaped piece extends from the strap or buckle forming a leg stop sized to receive a lower portion of a leg of a user therein.

The device of the invention is used by securing the bucket holder to the bucket to be held, which for the specific embodiment described, involves moving the buckle to open position and setting the bucket to be held into the open portion of the device. The apparatus is raised along the height of the bucket to about the middle of the bucket, and the buckle is moved to closed position moving the strap to closed looped position to snugly receive and hold the bucket in the looped strap. The buckle locks the loop in closed position around the bucket. The user then obtains the mixing device, such as the power drill with mixing attachment, and positions himself or herself in position for mixing the contents of the bucket with the leg stop against one of his or her legs. The particular leg chosen will depend upon the direction of rotation of the mixer which determines the direction of expected rotation of the bucket. The leg stop will be positioned against the leg in the direction of expected rotation. In this position, the user's leg in the leg stop easily prevents any rotation of the bucket.

Use of the holding apparatus of the invention provides a safe method of mixing material in a large bucket, particularly when using a drill-style stirring apparatus. The apparatus is particularly useful for a normal five gallon bucket which is used extensively for mixing materials, but can be sized for use with other size buckets as well.

### THE DRAWINGS

In the accompanying drawings, which show the best mode currently contemplated for carrying out the invention:

FIG. 1 is a pictorial view of the device of the invention closed around and holding a bucket, with the leg stop of the device shown against a user's leg standing in normal position for mixing material in the bucket with a power mixing device;

FIG. 2, a top plan view of the device of FIG. 1 in open condition showing a bucket in section in the open loop of the device;

FIG. 3, a fragmentary front elevation of the device showing the buckle in open condition and showing the open loop around the bucket taken on the line 3-3 of FIG. 2;

FIG. 4, a top plan view similar to that of FIG. 2, but showing the device in the closed condition fitting snugly around the bucket;

FIG. 5, a fragmentary front elevation of the device showing the buckle in closed condition and showing the closed loop snugly holding the bucket and taken on the line 5-5 of FIG. 4;

FIG. 6, an enlarged fragmentary horizontal section through the buckle in open condition taken on the line 6-6 of FIG. 3; and

FIG. 7, an enlarged fragmentary horizontal section through the buckle in closed condition taken on the line 7-7 of FIG. 5.

### DETAILED DESCRIPTION OF THE ILLUSTRATED EMBODIMENTS

The device of the invention includes a bucket holder which fits and locks around a bucket to be held and stabilized from spinning, particularly during the mixing of material in the bucket with a power mixer, and a leg stop extending from the bucket holder that fits against a user's leg to prevent spinning of the bucket.

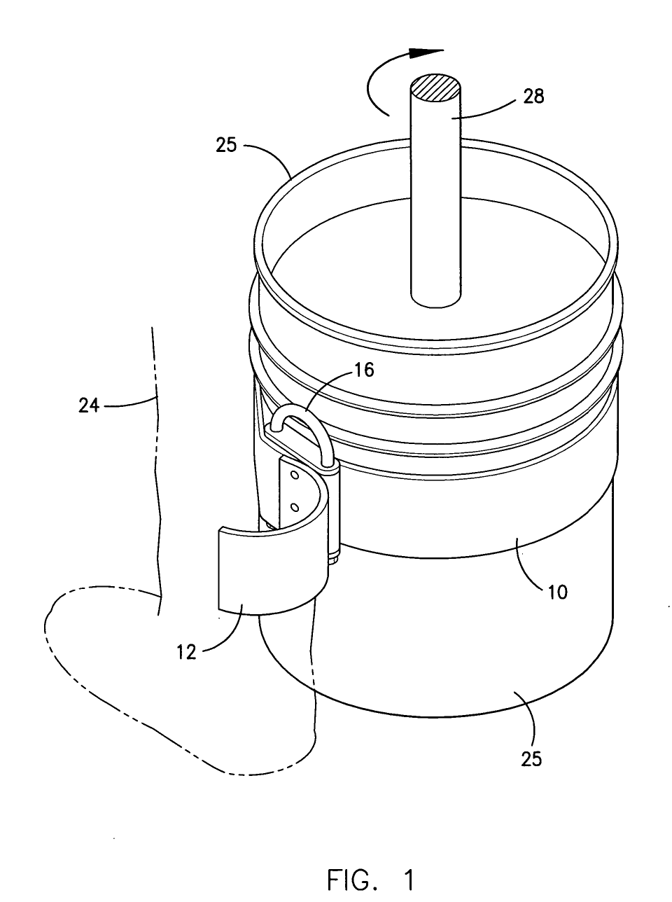

In the embodiment illustrated, the bucket holder includes a holding strap 10 of substantially flexible, but substantially nonstretchable material, looped into a generally circular configuration, with ends of the strap attached through a buckle or locking mechanism 11. A rigid U-shaped piece 12 extends from the strap or buckle and forms a leg stop sized to be receive around a lower portion of a leg of a user as shown in FIG. 1. The leg stop 12 can be lined with a soft material to cushion the stop against the user's leg. The holding strap 10 can be constructed from a variety of substantially flexible and substantially non-stretchable sheet materials, such as sheet metal, aluminum, tin, plastic coated or impregnated fabric, fabric, plastic, leather, chain, wood, or any other appropriate material. A strip of three inch wide sheet metal or a similar strip of poly plastic material, about thirty seven inches long, has been found to provide a satisfactory strap for holding a normal five gallon plastic bucket. Depending upon the material used for the strap, it may be desirable to line the strap with a slip resistant material, such as a soft plastic material, to more securely hold the bucket.

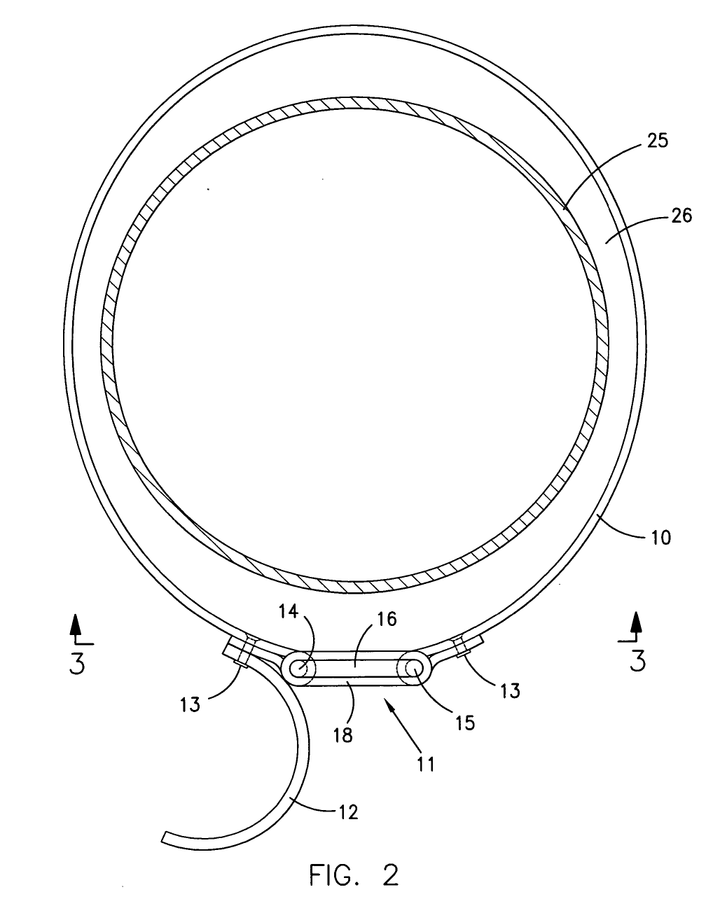

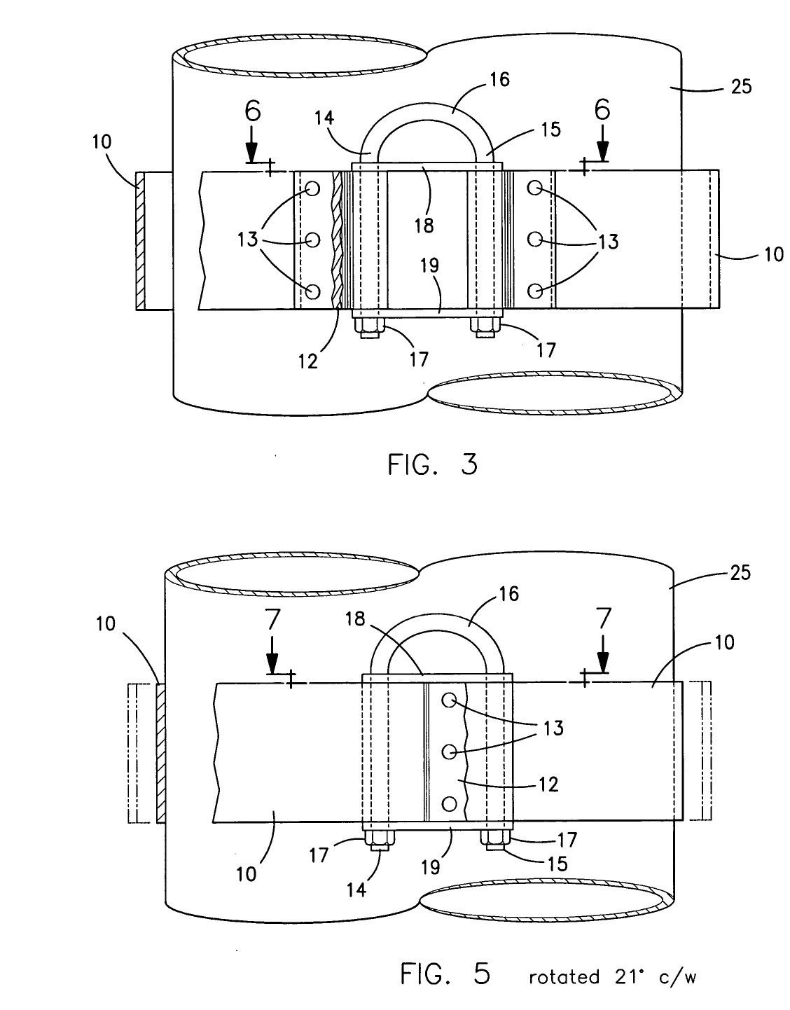

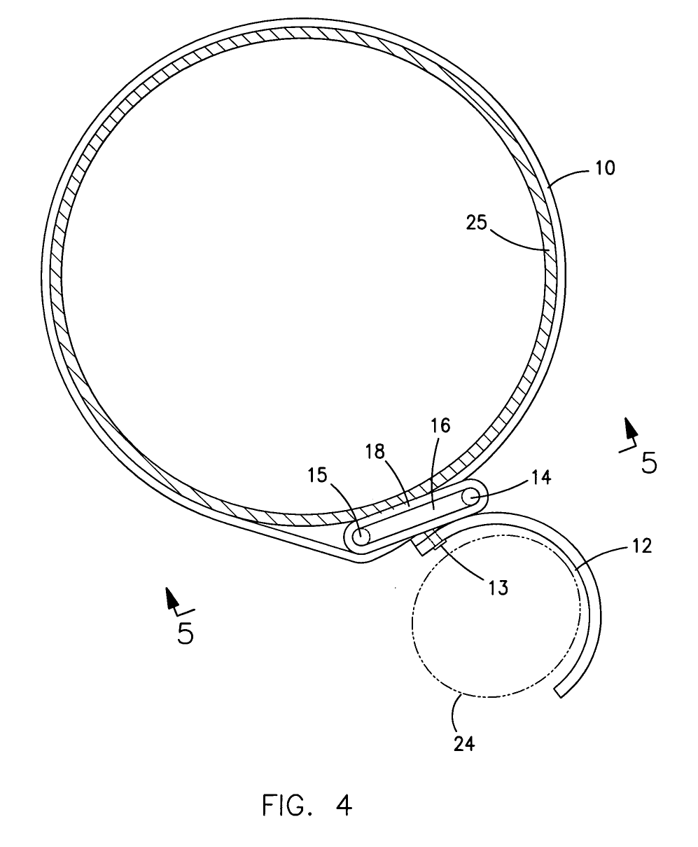

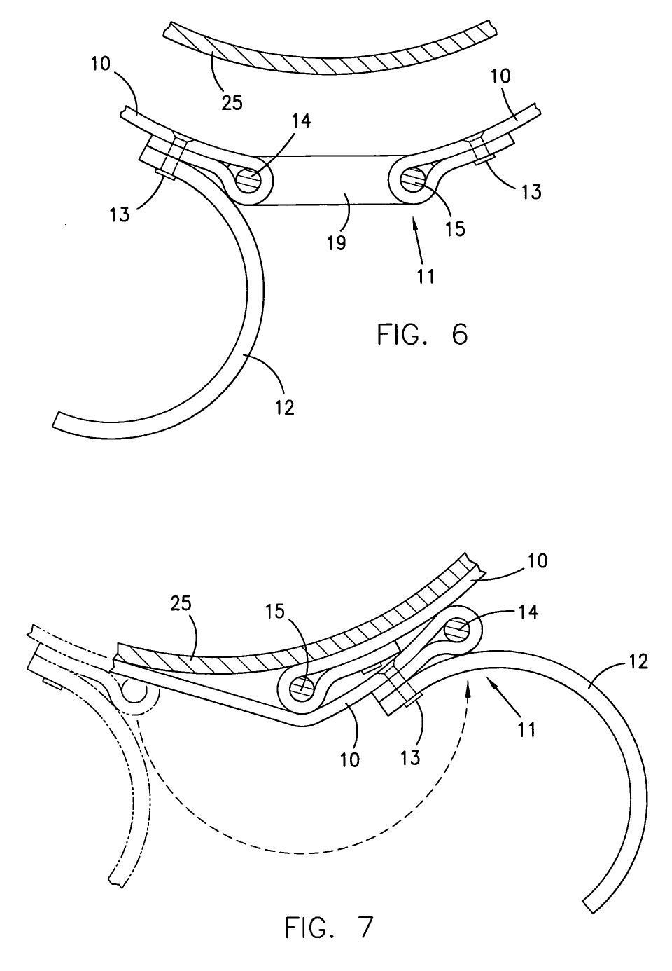

The ends of the holding strap 10 are folded back on themselves and secured, such as by bolts or rivets 13, to each encircle and rotatably hold respective buckle hinge pins 14 and 15, such as formed by the legs of U-bolt 16, FIGS. 3 and 5. U-bolt 16 is held in the folded over ends of the strap by nuts 17. Links 18 and 19 extend between hinge pins 14 and 15 above and below, respectively, the ends of the strap to further hold the hinge pins 14 and 15 in the encircling strap ends and to space and stabilize the hinge pins 14 and 15. The buckle 111 can be moved between an open position as shown in FIGS. 2, 3, and 6 which provides an enlarged loop formed by strap 10, and a closed position shown in FIGS. 4, 5, and 7, which provides a smaller loop of reduced diameter formed by strap 10. The device is sized to provide a closed position loop diameter that will snugly hold the bucket to be held by the device to prevent relative movement between the bucket and the strap. In many cases a bucket has tapered sides so the bucket has a slightly smaller diameter at the bottom than at the top. If necessary, the position of the device of the invention can be moved upwardly or downwardly on the bucket to provide the desired snug fit around the bucket. However, the device should preferably be positioned high enough on the bucket so that the leg stop 12 will rest against the user's leg rather than the user's foot.

The illustrated buckle 11 is constructed so that when moved to closed position, FIGS. 4, 5, and 7, the linked hinge pins 14 and 15 will move over center of the buckle so pin 14 will be biased by the pull of strap 10 inwardly against strap 10 so the buckle will remain in the closed position until manually moved from closed position back over center to allow the buckle to move to open position, FIGS. 2, 3, and 6. It will be realized that various buckle configurations, buckle locks, and buckle types may be used. Further, various other types of tighteners for closing the strap ends to form a loop when in closed condition and for tightening the strap loop snugly around the bucket to be held may also be used as means for holding the strap in a closed looped condition snugly around the bucket. For example, the ends of the strap may include flanges with a screw extending through the flanges so that the screw can be loosened to move the strap to open condition and tightened to move the strap to closed condition.

U-shaped leg stop 12 may be secured, such as by the bolts or rivets 13, to one end of the strap 10 where the end also is attached to the buckle. U-shaped leg brace 12 is sized to receive the leg 24 of a user therein, and may be a section, such as a half or 180 degree section, of four inch diameter plastic pipe. As indicated, cushioning material may be provided inside the leg stop where it abuts the leg. In the embodiment illustrated with the leg stop secured to the strap end shown, leg stop 12 can be used by the user to move the strap and buckle arrangement between the closed and open positions. It should be realized, however, that the leg stop could be attached to the strap at various other positions along the strap or could be attached to the buckle. Further, although the leg stop is shown as U-shaped to easily be received by a leg of the user and to maintain its position around the leg, the leg stop could be configured in various other shapes or could merely be a padded bar extending radially outward from the bucket holder.

The device of the invention, in its illustrated form, is used by moving the buckle to open position, FIG. 2, and setting the bucket 25 to be held into the open portion 26 of the device. The device is raised upwardly along the height of the bucket to about the middle of the bucket, and the buckle is moved to closed position moving the strap 10 to closed looped position around the bucket 25, as shown in FIGS. 4, 5, and 7, to snugly receive and hold the bucket 25 in the closed looped strap 10. The buckle locks the loop in closed position around the bucket. In this closed position, the device will stay attached to the bucket where positioned by the user intermediate the height of the bucket without being held in that position by the user. The user then picks up the mixing device, such as a power drill with mixing attachment, the shaft of the mixing attachment being shown as 28 extending from the bucket in FIG. 1, and positions himself or herself in position for mixing the contents of the bucket with one of his or her legs in the leg stop portion 12 of the apparatus, as shown in FIG. 1. In this position, the user's leg 24 in the leg stop 12 easily prevents any rotation of the bucket 25 held by closed looped strap 10. This is also the natural position in which the user would stand over the bucket to insert and use a power mixer, such as a power drill with mixing attachment. The apparatus is placed around the bucket in an orientation so that the direction of any rotation of the bucket will tend to tighten the strap around the bucket. In this way, the force of the drill-style stirring apparatus causes the looped portion of the invention to more tightly cinch the bucket in the closed strap loop ensuring that the bucket cannot rotate in the loop. The device then keeps the bucket from breaking free and/or spinning.

The orientation of the leg stop secured to the strap is such that with the strap cinched around the bucket in proper orientation so that any rotation of the bucket will tighten the strap, the leg stop, if curved, will be properly positioned to be received around the proper leg to prevent rotation. Most mixing devices will rotate in a clockwise direction. Therefore, as shown in FIG. 1, the leg stop is curved to engage the user's leg and to keep the stop from rotating in a clockwise direction. If the rotation of the mixing device is in a counterclockwise direction, the device merely needs to be turned upside down from the orientation shown in FIG. 1 to reverse the orientation of the buckle and the orientation of the leg stop so that the leg stop will engage the other leg of the user and stop rotation in the counterclockwise direction. It should be realized that not all buckle or other loop closing and tightening means will show any tightening effect with rotation of the bucket so in those cases the orientation of the holding device on the bucket will not matter. In those cases, the leg stop can be attached to the bucket holder without regard to its orientation with respect to the bucket holder and expected direction of spin of the bucket. The leg stop could even be rotatably attached to the bucket holder in those cases to adjust to the expected direction of spin.

Use of the holding apparatus of the invention provides a safe method of mixing material in a large bucket, particularly when using a drill-style stirring apparatus. The apparatus is particularly useful for a normal five gallon bucket which is used extensively for mixing materials, but can be sized for use with other size buckets as well, such as two and one half, two, and one gallon buckets. As used in this application and claims, the term bucket encompasses not only containers that might be customarily referred to as buckets, but also other similar types of containers in which materials can be mixed or otherwise processed and which need holding to prevent spinning or similar motions of the container.

While a particular buckle has been described in detail and a particular strap and buckle configuration has been shown which holds the strap in looped formation when both closed around the bucket and when in open condition, various other buckles can be used to cinch a holding strap around a bucket and various other configurations of strap and buckle combinations can be used. For example, the strap can form a loop to snugly hold the bucket when in closed condition, but the loop may be completely opened and not form a closed loop when the strap is in open condition. In this situation, an end of the strap would be passed through the buckle and cinched tightly around the bucket when moved from open to closed condition. Further, other types of bucket holding means from which a leg stop can extend can be used.

Whereas the invention is here illustrated and described with reference to embodiments thereof presently contemplated as the best mode of carrying out the invention in actual practice, it is to be understood that various changes may be made in adapting the invention to different embodiments without departing from the broader inventive concepts disclosed herein and comprehended by the claims that follow.

I claim:

1. A device for preventing a bucket from spinning during mixing of ingredients in the bucket, comprising:
a bucket holder to releasably fit around and hold the bucket to prevent relative movement between the bucket and the holder; and
a leg stop secured to and extending from the holder to, when a bucket is held in the holder, abut against the leg of a user to thereby hold the leg stop and holder from moving with respect to the user's leg, thereby holding the bucket from spinning.

2. A device for preventing a bucket from spinning according to claim 1, wherein the bucket holder comprises:
a strap; and
a buckle attached to the strap to hold the strap in a closed looped condition snugly around the bucket and to release the strap to an open condition wherein the strap extends loosely around the bucket so the bucket can be inserted into or removed from the holder.

3. A device for preventing a bucket from spinning according to claim 2, wherein the strap has opposite ends and the buckle is attached to at least one of the opposite ends of the strap.

4. A device for preventing a bucket from spinning according to claim 3, wherein the buckle is attached to each of the opposite ends of the strap to hold the strap in looped condition, and wherein the buckle has a closed condition to create the closed looped condition of the strap wherein the strap forms a loop of a preset diameter to fit snugly around the bucket to be held and an open condition to create the open condition of the strap wherein the strap forms a loop of a larger diameter to fit loosely around the bucket to be held to allow the bucket to be placed in the loop or removed from the loop.

5. A device for preventing a bucket from spinning according to claim 4, wherein the buckle includes a link that closes over itself to reduce or enlarge the circumference of the loop thereby reducing or enlarging the diameter of the loop.

6. A device for preventing a bucket from spinning according to claim 5, wherein the link closes over center as it closes over itself to thereby lock the link in closed condition until moved by a user to open condition.

7. A device for preventing a bucket from spinning according to claim 6, wherein the strap is a strip of a substantially nonstretchable, flexible material.

8. A device for preventing a bucket from spinning according to claim 7 wherein the strap is a metal strip.

9. A device for preventing a bucket from spinning according to claim 7 wherein the strap is a plastic strip.

10. A device for preventing a bucket from spinning according to claim 6, wherein the leg stop is substantially rigid and arcuate to receive the user's leg in the arc.

11. A device for preventing a bucket from spinning according to claim 10, wherein the leg stop is secured to and extends from the strap.

12. A device for preventing a bucket from spinning according to claim 10 wherein the leg stop extends from the buckle.

13. A device for preventing a bucket from spinning according to claim 10 wherein the leg stop extends from the attachment of the strap and buckle.

14. A device for preventing a bucket from spinning according to claim 2, wherein the leg stop is secured to and extends from the strap.

15. A device for preventing a bucket from spinning according to claim 2 wherein the leg stop extends from the buckle.

16. A device for preventing a bucket from spinning according to claim 2 wherein the leg stop extends from the attachment of the strap and buckle.

17. A device for preventing a bucket from spinning according to claim 1, wherein the leg stop is substantially rigid and arcuate to receive the user's leg in the arc.

18. A device for preventing a bucket from spinning according to claim 1, wherein the bucket holder comprises:
a strap; and
means for holding the strap in a closed looped condition snugly around the bucket and to release the strap to an open condition wherein the strap extends loosely around the bucket so the bucket can be inserted into or removed from the holder.

19. A device for preventing a bucket from spinning, comprising:
a strap;
a buckle attached to the strap to hold the strap in a closed looped condition snugly around the bucket and to release the strap to an open condition wherein the strap extends loosely around the bucket; and
a leg stop secured to and extending from one of the buckle or strap to abut against the leg of a user when the buckle is holding the strap in closed condition around the bucket to hold the leg stop and strap from moving, thereby holding the snugly received bucket from spinning.

20. A method for preventing a bucket from spinning during mixing of the contents of the bucket with a power mixing device, comprising the steps of:
obtaining a bucket with ingredients therein that need mixing;
obtaining a power mixing device that may tend to cause spinning of the bucket in a direction of spin when used to mix the ingredients in the bucket;
securing to the bucket a device for preventing a bucket from spinning, said device comprising:
a bucket holder to releasably fit around and hold the bucket to prevent relative movement between the bucket and the holder; and
a leg stop secured to and extending from the holder to, when a bucket is held in the holder, abut against the leg of a user to thereby hold the leg stop and holder from moving with respect to the user's leg, thereby holding the bucket from spinning;
while holding the power mixing device, standing over the bucket with one leg positioned against the leg stop of the device for preventing a bucket from spinning to prevent spinning movement of the leg stop in the direction that the power mixing device would tend to spin the bucket; and
operating the power mixing device to mix the ingredients of the bucket.
